(19) United States
(12) Patent Application Publication
(10) Pub. No.: US 2013/0206495 A1
(43) Pub. Date: Aug. 15, 2013

(54) Ignition interlock system

(71) Applicant: David M. Westbrook, Scottsdale, AZ (US)

(72) Inventor: David M. Westbrook, Scottsdale, AZ (US)

(21) Appl. No.: 13/815,194

(22) Filed: Feb. 8, 2013

Related U.S. Application Data
(60) Provisional application No. 61/633,340, filed on Feb. 9, 2012.

(51) Int. Cl. B60K 28/06

(52) U.S. Cl. CPC B60K 28/063
USPC 180/272

(57) ABSTRACT

An ignition interlock system, prior to allowing a driver to operate a vehicle, confirms the driver's identity and confirms whether the driver has ingested a prohibited substance. Equipment in the ignition interlock system is transferable between vehicles and can be utilized to retrofit an existing vehicle. The ignition interlock system communicates with various law enforcement and other agencies.

This application claims priority based on provisional patent application Ser. No. 61/633,340, filed Feb. 9, 2012.

This invention relates to vehicles.

More particularly, the invention relates to a method and apparatus to control the ignition system of a vehicle.

Those of skill in the art have for many years designed and strived to improve systems which activate and deactivate the ignition system of a vehicle under certain conditions. Accordingly, it would be highly desirable to provide an improved system for controlling the ignition system of a vehicle.

Therefore, it is a principal object of the invention to provide an improved ignition control system.

This and other, further and more specific objects and advantages of the invention will be apparent to those skilled in the art from the following detailed description thereof, taken in conjunction with the drawings, in which:

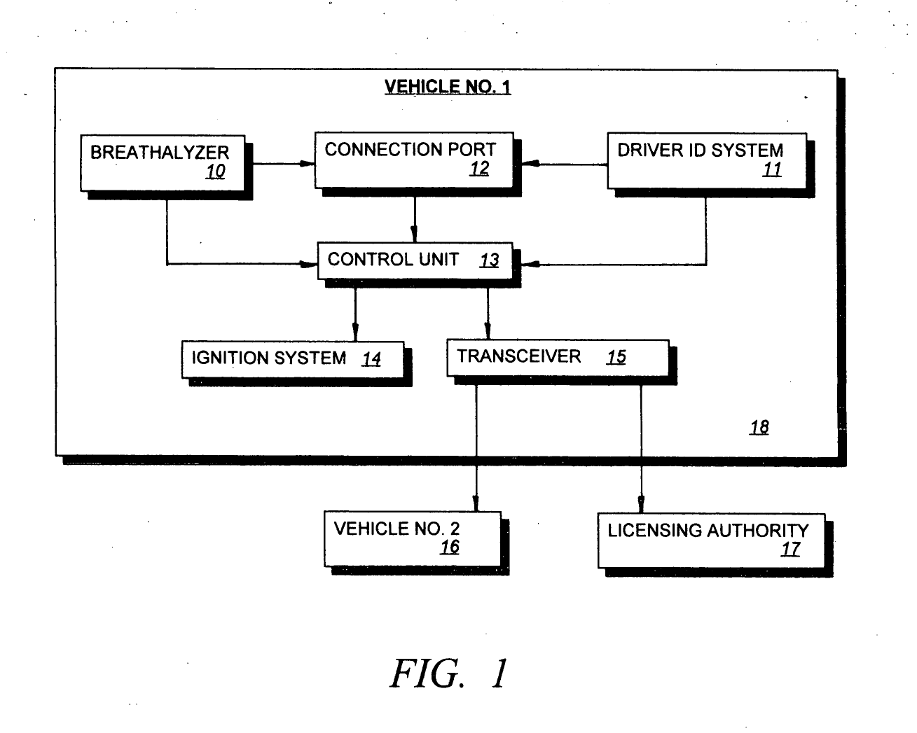

FIG. 1 is a block diagram illustrating a first vehicle constructed in accordance with the principles of the invention;

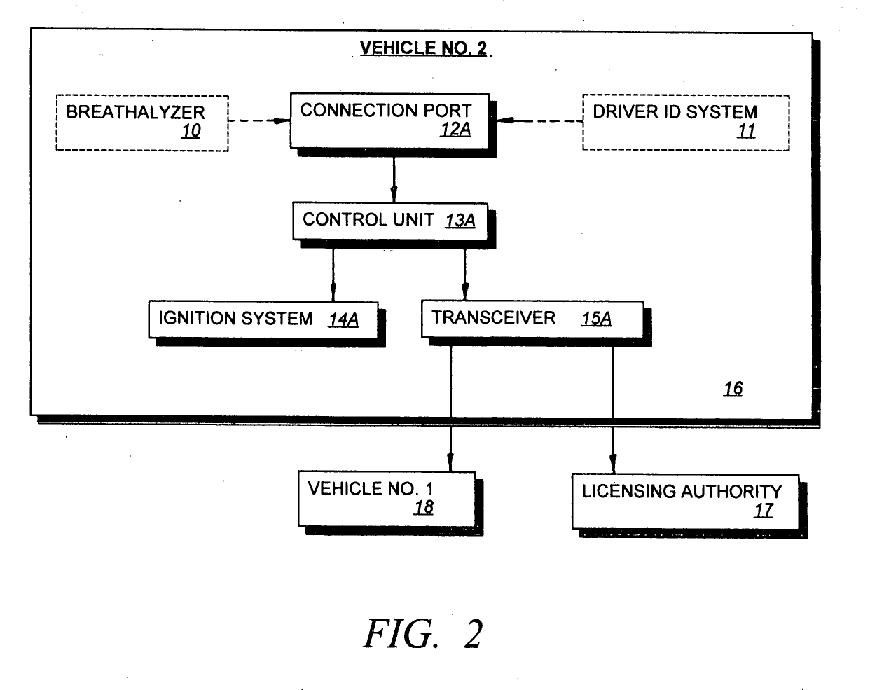

FIG. 2 is a block diagram illustrating a second vehicle constructed in accordance with the principles of the invention;

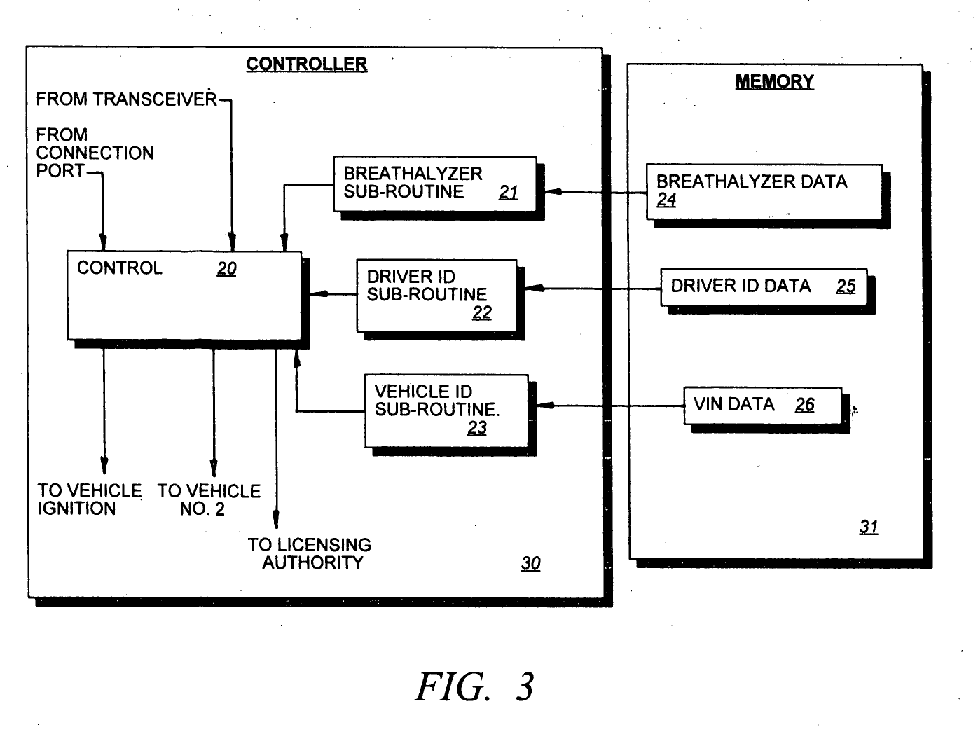

FIG. 3 is a block diagram illustrating the control unit of the first vehicle; and,

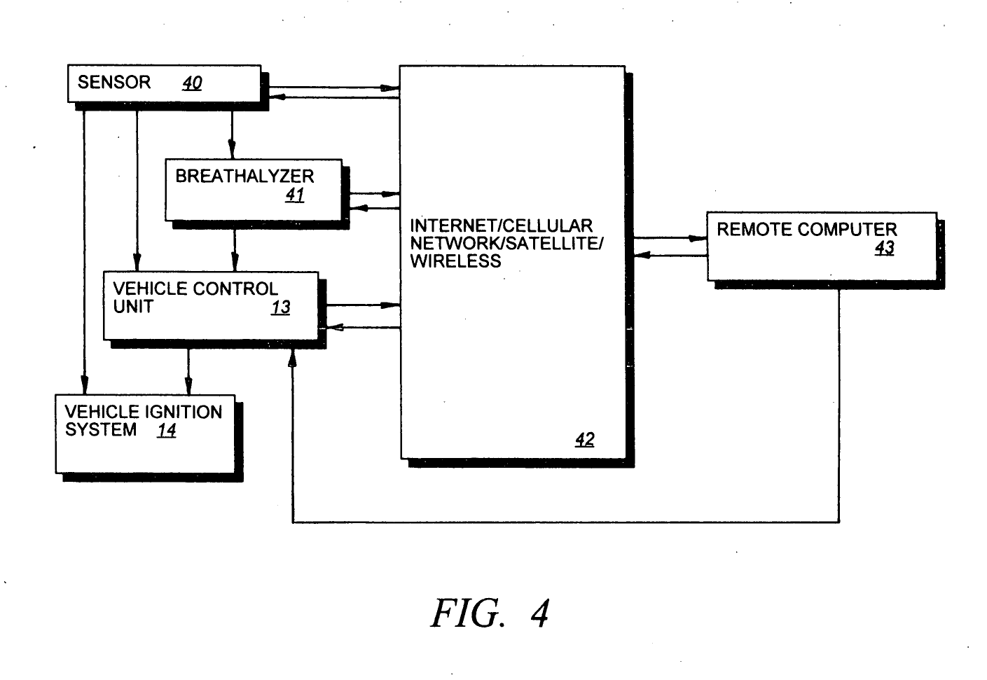

FIG. 4 is a block diagram illustrating a vehicle ignition interlock system constructed in accordance with one embodiment of the invention.

Briefly, in accordance with the invention, provided is an improved ignition interlock system. The system includes a first vehicle. The first vehicle includes a first ignition system; a first control unit operably associated with the first ignition system to activate and deactivate the first ignition system; a first control port operably associated with the first control unit; and, a first OEM computer. The second vehicle includes a second ignition system; a second control unit operably associated with the second ignition system to activate and deactivate the second ignition system; a second control port equivalent to the first control port and operably associated with the second control unit; and, a second OEM computer. The system also includes at least a first portable breathalyzer component detachably mountable to either of the first control port and the second control port to generate breathalyzer signals for transmission to either of the first and second control units via the first and second control port, respectively. The system also includes first driver identification apparatus mounted in the first vehicle and used in the generation of first identification signals for transmission to the first control unit; second driver identification apparatus mounted in the second vehicle and used in the generation of second identification signals for transmission to the second control unit. The first control unit receives and assesses the breathalyzer signals for a driver and the first identification signals for the driver to determine if the first ignition system should be activated. The second control unit receives and assesses the breathalyzer signals for the driver and the second identification signals for the driver to determine if the second ignition system should be activated.

Turning now to the drawings, in which like reference characters refer to corresponding elements throughout the several view, and which are presented by way of example and not limitation, FIG. 1 illustrates the first vehicle 18 in an ignition interlock system constructed in accordance with the invention. The first vehicle 18 includes a first ignition system 14, a first control unit 13 operably associated with the first ignition system 14 to activate and deactivate the first ignition system 14, and, a first control port 12 operably associated with the first control unit 13.

The first vehicle also includes a first OEM computer (not shown). The OEM computer is part of the original equipment on the vehicle when the vehicle is sold new. In one embodiment of the invention, the functions of control unit 13 are incorporated in the OEM computer such that when vehicle 18 is sold new, a breathalyzer 10 and driver ID system can be connected to the OEM computer and it is not necessary to incorporate a supplemental control unit 13 in vehicle 18. Modifying an OEM computer in a vehicle after the vehicle has been constructed or sold does not appear practical at this time because OEM computers typically are sealed systems and each vehicle manufacturer uses its own computer design. Therefore, in the practice of the invention it is important that a control unit 13 be provided to control the ignition system 14 and, if necessary, to deactivate the ignition system 14 and prevent operation of vehicle 18.

The first vehicle also includes a transceiver 15 used by control unit 13 to receive and transmit signals to and from a second vehicle 16 and a licensing authority 17.

The interlock system also includes a second vehicle 16 illustrated in FIG. 2. The second vehicle 16 includes a second ignition system 14A, a second control unit 13A operably associated with the second ignition system 14A to activate and deactivate the second ignition system 14A, and, a second control port 12A operably associated with the second control unit 13A.

The second vehicle 16 also includes a second OEM computer (not shown). The second OEM computer is part of the original equipment on the vehicle when the vehicle is sold new. In one embodiment of the invention, the functions of the second control unit 13A are incorporated in the second OEM computer such that when vehicle 16 is sold new, a breathalyzer 10 and driver ID 11 system can be connected to the second OEM computer and it is not necessary to incorporate a supplemental control unit 13A in vehicle 16. As noted, modifying an OEM computer in a vehicle after the vehicle has been constructed or sold does not appear practical at this time because OEM computers typically are sealed systems and each vehicle manufacturer uses its own computer design. Therefore, in the practice of the invention it is important that a control unit 13A be provided to control the ignition system 14A to deactivate, if necessary, the ignition system 14A and prevent operation of vehicle 18.

The second vehicle 16 also includes a transceiver 15A used by control unit 13A to receive and transmit signals to and from first vehicle 18 and a licensing authority 17.

Vehicle 16, 18 can comprise an automobile, truck, tractor, or any other vehicle which utilizes an ignition system to turn the vehicle on and off.

Although a breathalyzer 10 in the first vehicle 16 can be permanently installed in vehicle 16 (or in any other vehicle(s) 18), it is presently preferred that breathalyzer 10 is detachably secured to connection port 12 such that breathalyzer 10 can be disconnected from port 12 and attached to port 12A in the second vehicle. Consequently, in FIG. 2, beathalyzer 10 is shown in dashed outline to indicated that the breathalyzer 10 in FIG. 1 can be removed from vehicle 18 and attached to port 12A in vehicle 16. Similarly, the driver ID system 11 in FIG. 1 can be detachably secured to port 12 such that it can be disconnected from port 12 and reconnected to port 12A in vehicle 16 (FIG. 2). It is presently preferred, however, that each vehicle 16, 18 have its own driver ID system 11 permanently installed in the vehicle.

In some embodiments of the invention, the breathalyzer 10 in a vehicle 16, 18 is not physically secured to a connection port 12 or to a control unit 13 and, instead, transmits signals wirelessly directly to control unit 13. Likewise, a driver ID system 11 need not be physically secured to a connection port 12 or to a control unit 13 and can, instead, transmit signals wirelessly to control unit 13.

The function of breathalyzer 10 is to test the breath of a driver when the driver enters a vehicle 16, 18. Breathalyzer 10 tests for the presence in a driver's breath of alcohol or of any other desired pharmaceutical or composition. When a desired composition(s) is detected in a driver's breath at a selected concentration, breathalyzer 10 generates signals which notify control unit 13, 13A of the presence of the composition in the driver's breath. The signals from breathalyzer 10 can simply indicate that a driver should not be allowed to drive a vehicle 16, 18, can indicate the concentration of a particular composition in a driver's breath, can indicate the name of the composition detected, or can indicate any other desired information that control unit 13, 13A can utilize in determining whether to activate or deactivate the ignition system 14, 14A. Activation of ignition system 14, 14A is typically accomplished by closing a switch which permits ignition system 14, 14A to electronically activate the starter system of a vehicle when a key is placed in the ignition of the vehicle and turned to the “on” position. Deactivation of ignition system 14, 14A is typically accomplished by opening a switch which prevents ignition system 14, 14A from electronically activating the starter system of a vehicle when a key is placed in the ignition of the vehicle and turned to the “on” position. The construction and operation of breathalyzer equipment is well known in the art and is not discussed in detail herein. Breathalyzer equipment is also readily available in market as demonstrated by the web site www.breathalyzer.net.

The function of driver ID system 11 is to identify the individual who is attempting to drive vehicle 16, 18. The system 11 can, for example, comprise a fingerprint reader, comprise a retinal eye scan device, comprise a voice recognition system, or comprise a system which requires a password or other activation code to be entered. Driver ID system 11 is programmed to allow only a certain individual(s) to drive vehicle 16, 18. The fingerprint, retinal eye scan, etc. for that individual is maintained in the memory of a microprocessor in system 11, or, is contained in the memory of control unit 13, 13A. If the fingerprint, retinal eye scan, etc. of an individual seated in the driver's seat of vehicle 16, 18 does not match data that is stored in system 11 or control unit 13, 13A, then control unit 13A will not activate ignition system 14, 14A (or will deactivate ignition system 14, 14A).

In some embodiments of the invention, the ignition interlock system of the invention includes auxiliary sensors which produce signals that are transmitted to control unit 13, 13A. The signals from such sensors indicate whether an individual is seated in the driver's seat with his or her seat belt secured, and whether there are individuals in the vehicle other than the individual in the driver's seat of the vehicle. If there is an individual(s) other than the driver in the vehicle, the breathalyzer 10 and driver ID system 11 will not function and the vehicle can not be driven, or, even if the breathalyzer 10 and driver ID system 11 do function, control unit 13, 13A will not permit the vehicle 16, 18 to be driven (i.e., control unit 13, 13A will deactivate the ignition system 14, 14A or will otherwise disable the vehicle). Similarly, if there is not an individual seated in the driver's seat with the seat belt fastened, the breathalyzer 10 and driver ID system 11 will not function and the vehicle can not be driven, or, even if the breathalyzer 10 and driver ID system 11 do function, control unit 13, 13A will not permit vehicle 16, 18 to be driven.

Breathalyzer 10, port 12, driver ID system 11, control unit 13, and transceiver 15 can be OEM equipment on a new vehicle; however, in some embodiments of the invention, it is anticipated that breathalyzer 10, port 12, driver ID system 11, etc. will be retrofit in existing vehicles and that control unit 13 will be installed so that a relay or switch or some other control device is located at some point intermediate the ignition switch and the starter on the vehicle so that unit 13, 13A can simply open and close a relay or switch (or operate some other control device) to deactivate and activate, respectively, the ignition system of the vehicle.

FIG. 3 illustrates a control unit 13(or 13A). Unit 13 includes a controller 30 and memory 31. Control 20 receives signals from connection port 12 (or directly from breathalyzer 10 and/or driver ID system 11), from transceiver 15, from breathalyzer sub-routine 21, from driver ID sub-routine 22, and from vehicle ID sub-routine 23. Control 20 generates and sends signals to vehicle ignition 14, to vehicle 18, and to a licensing authority 17. Breathalyzer sub-routine 21 receives data 24 from memory 31. Sub-routine 21 is used to determine if a driver passed a breathalyzer test. Driver ID sub-routine 22 receives data 25 from memory 31, and, vehicle ID sub-routine 23 receives VIN (vehicle identification number) data for a vehicle 16, 18 from memory 31. Sub-routine 22 is used to determine if a driver is authorized to drive a vehicle 16, 18 and is require to pass a breathalyzer test. Sub-routine 23 is used to identify the vehicle 16, 18.

Licensing authority 17 can comprise an insurance company, a state driver's license issuing authority, a law enforcement agency, or any other desired organization in connection with the licensing, operation, insuring, or monitoring of a vehicle 16, 18, or, in connection with the licensing or monitoring of an individual driving the vehicle. Any desired data stored or generated in or by control unit 13, 13A can be transmitted to a licensing authority 17 by transceiver 15, 15A or by any other desired means.

FIG. 4 illustrates a vehicle ignition interlock system in accordance with the invention. A breath sensor 40 analyzes a driver's breath and generates signals to breathalyzer 41, to vehicle control unit 13, to vehicle ignition system 14, or to a signal transmission system (Internet, cellular network, satellite, or wireless) 42. System 42 transmits signals to a remote computer 43. Computer 43 is not part of vehicle 16, 18 and can, for example, be a portable hand-held unit or a desk-top computer system. Breathalyzer 41 can transmit signals to unit 13 or to transmission system 42. Control unit 13 can transmit signals to ignition system 14 or to transmission system 42. Remote computer can transmit signals directly to unit 13, or, to unit 13 via a signal transmission system 42. Computer 43 can also transmit signals direction to sensor 40, breathalyzer 41, or unit 13, or, to sensor 40, breathalyzer 41, or unit 13 via a signal transmission system 42. Remote computer 43 can have capabilities equivalent to that of control unit 13, 13A, and can have other capabilities which enable computer 43 to transmit data and control signals to sensor 40, breathalyzer 41, or ignition system 14.

In use, a driver sits in the driver's seat in vehicle 18 (or 16). He utilizes breathalyzer 10 and driver ID system 11. Breathalyzer 10 and driver ID system 11 generate signals which travel to control unit 13. If the driver passes the breathalyzer analysis (and does not have any prohibited compositions in his breath) and if the driver is, per driver ID system 11, authorized to drive vehicle 18, control unit 13 allows ignition system 14 to function so the driver can start the car. If while the driver is operating the vehicle, breathalyzer 10 detects a prohibited composition in the driver's breath, or in the atmosphere inside vehicle 18, control unit 13 turns off the vehicle 18 as soon as vehicle 18 is not moving.

As described above, the invention relates to an ignition interlock system which is mounted on a first vehicle and includes a first control unit 13 and a first breathalyzer 10 (or other device used to detect alcohol or other drugs in the body of a driver) used to periodically test a driver, or prospective driver, to determine if the driver (1) is authorized to drive the first vehicle 18 (i.e., the driver passes a breathalyzer test), and (2) has ingested an alcoholic beverage, or has ingested an unacceptable quantity of an alcoholic beverage and is therefore not authorized to drive the vehicle. If the breathalyzer detects an unacceptable level of alcohol in a driver, this information is transmitted to the first control unit 13 in the ignition interlock system, and, the first control unit 13 (or, as discussed below, another remote control unit) in some manner functions to prevent operation of a vehicle. If the prospective driver is trying to initially start a vehicle, and the breathalyzer detects an unacceptable amount of alcohol in the driver's breath, the first control unit 13 prevents the vehicle from starting. If the breathalyzer detects an unacceptable level of alcohol in a driver while a vehicle is moving, the first control unit 13 can take any desired action to prevent the driver from continuing to drive the vehicle. For example, if the vehicle stops at a stop sign or traffic light, unit 13 can turn off the motor of the vehicle. Or, if the driver refuses to pull the car over at the direction of the controller, unit 13 can contact law enforcement or a local motor vehicle department to dispatch authorities to pull the vehicle over, and so on.

The breathalyzer 10 typically includes a mask or other collection device which is placed over or near the mouth of a driver to collect a sample of the driver's breath. The breathalyzer also includes a breath analyzer which is operatively associated with the collection device and which analyzes the sample of the driver's breath obtained by the collection device. The analyzer generates an analysis signal which indicates the quantity of alcohol (or other drug or composition) in a driver's breath, or, generates an analysis signal which indicates whether the quantity of alcohol is acceptable, or, only generates an analysis signal when the quantity of alcohol is not acceptable. Any signal generated by the analyzer is transmitted to the first control unit 13, which evaluates the data in the signal and takes the necessary action, if any, to stop the driver from operating the vehicle.

Another component of the interlock system is a supplemental identification apparatus, or driver ID system 11, which confirms that the driver is authorized to drive the first vehicle 18 assuming that the driver, if required, passes a breathalyzer test. The apparatus can, as noted, comprise a fingerprint scanner mounted in the vehicle, comprise a voice identification system mounted in the vehicle, comprise a retinal scanner mounted in the vehicle, or comprise a computer mounted in the vehicle which requires the entry of a password or other information. A fingerprint scanner is presently preferred. Data from the supplemental identification apparatus communicates with the control unit 13 of the interlock system to confirm the identity of the driver. The memory in unit 13 includes reference data which identifies drivers who are authorized to drive the vehicle, and which indicates if a driver must pass a breathalyzer test. When unit 13 receives fingerprint data from the identification apparatus, it confirms the identity of the driver by comparing the reference data to the fingerprint data generated by the fingerprint scanner, and also determines if the driver must pass a breathalyzer test.

In an alternate embodiment of the invention, the reference data identifying the driver(s) authorized to drive the vehicle 18 is maintained at a web site and/or computer 43 at a remote location, and, when the control unit 13 receives data from the fingerprint scanner in the vehicle, the unit 13 communicates wirelessly with the web and/or remote computer 43 to determine if the driver is authorized to drive the vehicle, and if the driver must pass an initial breathalyzer test and, possibly, additional periodic “rolling tests” while the driver is driving the vehicle 18.

In the preferred embodiment of the invention, at least a second vehicle 16 is provided along with the primary vehicle. The second vehicle includes a fingerprint scanner or other identification apparatus 11A. The second vehicle includes a second control unit 13A. The second control unit 13A can (like the first control unit 13) include reference data (for example, fingerprint data) which identifies drivers who are authorized to operate the vehicle 16 and which indicates if an authorized driver must pass a breathalyzer test(s). A driver wishing to utilize the second vehicle 16 must utilize the fingerprint scanner. Data from the fingerprint scanner is sent to the second control unit 13A, wirelessly to the first control unit 13, or wirelessly to a remote computer 43 or Internet web site. The second control unit 13A, first control unit 13, remote computer 43, or web site, as the case may be, confirms that the driver is authorized to drive the second vehicle and also indicates if the driver must pass a breathalyzer test prior to using the second vehicle. The second vehicle can include its own separate second breathalyzer (different from the breathalyzer in the first vehicle 18). The second breathalyzer would be used to test the breath of a prospective driver in a manner comparable to that described for the breathalyzer in the first vehicle, however, it is presently preferred that the first breathalyzer, or at least the air collection device or sensor thereof, be detachable and transferrable between the first and second vehicles so that providing two separate breathalyzers is not necessary. Further, it is preferred that both the collection device and the analyzer (i.e., the entire breathalyzer) be transferrable between and usable in each vehicle. Data generated by the analyzer when the breathalyzer is detachably mounted in the second vehicle 16 can be processed by the second control unit 13A, can be wirelessly transmitted to the first control unit 13 for analysis, wirelessly transmitted to by a remote computer 43 for analysis, or wirelessly transmitted to an Internet web site for analysis.

If a breathalyzer in the second vehicle 16 determines that a driver has consumed an unacceptable amount of alcohol, operation of the second vehicle 16 is prevented by one or more of the second control unit 13A, the first control unit 13, the remote computer 43, or the Internet web site, as the case may be, commanding the ignition interlock apparatus in the second vehicle to deactivate the ignition system in the second vehicle.

In another embodiment of the invention, the first control unit 13 is detachable from the first vehicle 18 and detachably mountable in the second vehicle 16 along with the breathalyzer from the first vehicle 18.

In a further embodiment of the invention, the fingerprint scanner is detachable from the first vehicle is detachably mountable in the second vehicle 16.

Bluetooth or any other desired technology can be utilized to facilitate communication between the first and second vehicles, or between the vehicles and a remote computer 43 or Internet web site. Bluetooth technology is well known and is a wireless technology that enables devices such as portable computers, cell phones, and portable handheld devices to connect to each other and to the Internet.

In still a further embodiment of the invention, one of the vehicles is a motorcycle. In yet another embodiment, the collection device of the breathalyzer is mounted on a motorcycle helmet or otherwise on the person of a motorcycle driver and communicates wirelessly with other components of the ignition interlock system mounted on the motorcycle. In yet still another embodiment of the invention, the breathalyzer analyzer is mounted on a motorcycle helmet or otherwise on the person of a motorcycle driver and communicates wirelessly with other components of the ignition interlock system mounted on the motorcycle.

In some embodiments of the invention, when the ignition interface system of the invention is utilized, it interfaces with existing computer components in a vehicle, either by utilizing appropriate interface software or by utilizing necessary firmware or other apparatus in conjunction with existing computer components in a vehicle.

In one embodiment of the invention, when the ignition interlock system of the invention is utilized, a vehicle can only be utilized after the ignition interlock system is activated by a control computer 43 or control Internet web site that is remote from the vehicle. The control computer or control Internet web site activates the ignition interlock system only after the control computer or control Internet web site has analyzed data from the fingerprint scanner (or other identification apparatus in the vehicle) and confirmed (1) that the person whose fingerprint is scanned is authorized to drive the vehicle, and (2) whether the person, if authorized to drive the vehicle, must be subjected to breathalyzer tests. Communication between (1) the fingerprint scanner (or control unit 13, etc.) in the vehicle and (2) the control computer 43 or control Internet web site preferably is accomplished wirelessly.

In one embodiment of the invention, the vehicle interlock system includes a GPS unit or other location unit mounted on the vehicle to detect the location of the vehicle, preferably in real time.

In a further embodiment of the invention, a driver is required to periodically utilize the fingerprint scanner (or other identification apparatus) while the vehicle being operated by the driver is in motion. If the fingerprint scanner is not utilized as required while the vehicle is in motion, the ignition interlock system of the invention takes steps necessary to stop operation of the vehicle.

In accordance with some embodiments of the invention, the interlock system must, in order to be operated in accordance with the invention, be able to determine the VIN or some other identification data of each vehicle. For example, each control unit 13, 13A or fingerprint scanner mounted in a vehicle can contain this information.

Any data generated by the ignition interlock system of the invention can be sent to a motor vehicle department, law enforcement agency, or any other organization monitoring the activity of a DUI driver who is required to have a breathalyzer test prior to operating and during the operation of any mechanically powered vehicle including, but not limited to, automobiles, trucks, motorcycles, boats, ships, snowmobiles, and airplanes. The ignition interlock system of the invention can be utilized on and incorporated in any desired mechanically powered vehicle.

Having described my invention in such terms as to enable those of skill in the art to understand and practice the invention, and having described embodiments thereof,

I claim:

1. An ignition interlock system including
(a) a first vehicle including
(i) a first ignition system,
(ii) a first control unit operably associated with said first ignition system to activate and deactivate said first ignition system,
(iii) a first control port operably associated with said first control unit,
(iv) a first OEM computer;
(b) a second vehicle including
(i) a second ignition system,
(ii) a second control unit operably associated with said second ignition system to activate and deactivate said second ignition system,
(iii) a second control port equivalent to said first control port and operably associated with said second control unit,
(iv) a second OEM computer;
(c) at least a first portable breathalyzer component detachably mountable to either of said first control port and said second control port to generate breathalyzer signals for transmission to either of said first and second control units via said first and second control port, respectively;
(d) first driver identification apparatus mounted in said first vehicle and used in the generation of first identification signals for transmission to said first control unit;
(e) second driver identification apparatus mounted in said second vehicle and used in the generation of second identification signals for transmission to said second control unit;
said first control unit receiving and assessing said breathalyzer signals for a driver and said first identification signals for said driver to determine if said first ignition system should be activated, and
said second control unit receiving and assessing said breathalyzer signals for said driver and said second identification signals for said driver to determine if said second ignition system should be activated.
